(19) United States
(12) Patent Application Publication
(10) Pub. No.: US 2017/0360090 A1
(43) Pub. Date: Dec. 21, 2017

(54) Smart Phone E-Cigarette

(71) Applicant: Daniel Grossfeld, Hicksville, NY (US)

(72) Inventor: Daniel Grossfeld, Hicksville, NY (US)

(21) Appl. No.: 15/186,735

(22) Filed: Jun. 20, 2016

(51) Int. Cl. A24F 47/00; H04M 1/02

(52) U.S. Cl. CPC A24F 47/008; H04M 1/0254

(57) ABSTRACT

Methods and apparatus for vaporizing a substance for inhalation by a user. A disposable e-cigarette cartridge retains the substance, in either liquid or solid form, and includes a vaporizer. The cartridge may be detachably coupled to a control module, which is, in turn, detachably coupled to a mobile device, such as a smart phone. Vaporization of the substance in the e-cigarette cartridge is powered and controlled by the mobile device.

### TECHNICAL FIELD

The present invention relates to apparatus and methods for vaporizing substances for inhalation, and, more particularly, to apparatus and methods for powering and controlling such function from a smart phone or other mobile device.

### BACKGROUND ART

Invention of the modern e-cigarette, otherwise referred to as a personal vaporizer, is typically attributed to Hon Lik, whose 2003 development has seen rapid commercialization. In an e-cigarette, a substance is atomized for inhalation either ultrasonically or by means of a heating element. The atomized substance can then be inhaled by a user. Configurations of the e-cigarette are known that have a power source integral with the e-cigarette itself, or, alternatively, the e-cigarette may draw the power required to produce vapor from an external power source such as a battery.

Several suggestions have been advanced for use of an e-cigarette in conjunction with a mobile phone. One is described in U.S. Pat. No. 9,197,726, to Stanimirovic, where a protective case designed to envelop a mobile phone contains a battery and an e-cigarette element, allowing for the battery to power both the e-cigarette and the mobile phone. A combination of a cellphone and a vaporizer, marketed as a “cellular vaping phone,” is described at https://store.vaporcade.com/collections/Jupiter. Finally, in US Published Patent Application 2015/0181945, to Tremplay (hereinafter, Tremplay '945), an e-cigarette having its own integral power source is controlled remotely by an external communication device, such as a smartphone or computer. Tremplay '945 is incorporated herein by reference.

Prior suggestions for the use of e-cigarettes in conjunction with phones have been deficient in that they have either required a dedicated and customized phone device, or else have provided, or required, a separate power source. Those deficiencies are overcome in the present invention, as described below.

### SUMMARY OF EMBODIMENTS OF THE INVENTION

In accordance with embodiments of the invention, apparatuses and methods are provided for vaporizing a substance for inhalation by a user. One method has steps of:

coupling an e-cigarette cartridge that includes a vaporizer to a control module;

coupling the control module to a mobile device;

coupling electrical power from the mobile device to the control module;

coupling electrical power from the control module to the e-cigarette cartridge; and

vaporizing the substance within the e-cigarette cartridge.

In accordance with alternate embodiments of the invention, coupling the e-cigarette cartridge to the control module may include coupling the e-cigarette cartridge by insertion directly into the control module. Methods may also have a step of sensing that the substance is being inhaled by a user. Coupling the control module to the mobile device may include coupling the control module by insertion of an electrical connector directly to the mobile device.

In accordance with another embodiment of the present invention, the method may also include controlling performance characteristics of the e-cigarette cartridge by instructions derived from the mobile device.

In accordance with another aspect of the invention, a system is provided for vaporizing a substance, where the system has an e-cigarette cartridge with no integral power source and a control module, having no integral power source either, for receiving the e-cigarette cartridge. The control module has an electrical connector specifically adapted for connection to a mobile device and for deriving power therefrom. The e-cigarette cartridge may also include a receptacle volume for retaining the substance for vaporization.

In accordance with yet another aspect of the invention, an e-cigarette cartridge is provided for use in a system, wherein the e-cigarette cartridge has a receptacle volume for containing a substance to be vaporized, a sensor for detecting inhalation through the e-cigarette cartridge by a user and generating a sensor signal, a connector for coupling the sensor signal to a control module, and a vaporizer for vaporizing the substance upon receipt of a control signal from the control module. The e-cigarette cartridge may also have a heating element for vaporizing the substance.

### BRIEF DESCRIPTION OF THE DRAWINGS

The foregoing features of the invention will be more readily understood by reference to the following detailed description, taken with reference to the accompanying drawings, in which:

FIG. 1 is a schematic view of a disposable e-cigarette cartridge and a control module coupled to a mobile device, in accordance with an embodiment of the present invention;

FIG. 2A is a perspective view of a disposable e-cigarette cartridge and a control module in a decoupled configuration, in accordance with an embodiment of the present invention, while FIG. 2B is a side view of the components of FIG. 2A;

FIG. 3 is a perspective view of an e-cigarette assembly in accordance with an embodiment of the present invention;

FIGS. 4A and 4B show side views of the disposable e-cigarette cartridge and the control module of FIG. 2A, in decoupled and coupled configurations, respectively;

FIG. 5 is a schematic cutaway illustration of components of an e-cigarette assembly in accordance with an embodiment of the present invention.

### DETAILED DESCRIPTION OF EMBODIMENTS OF THE INVENTION

### Definitions

The term “mobile device,” as used herein and in any appended claim, shall refer to a member of the class of consumer products that includes computing devices small enough to be hand-held, having, at least, a display screen with touch input and/or a miniature keyboard. The term “mobile device” shall encompass smart phones, tablets, phablets, etc., without limitation.

The term “vaporizer” shall encompass any structure that causes molecules in either a liquid or a solid phase to be given off such that they are either in a gaseous phase or else suspended in a gas. Thus, when droplets are formed that are suspended in air constituting a mist or a smoke, they may be said to have been “vaporized,” as the term is used in the present document. Examples of vaporizers, in accordance with the foregoing definition, include atomizers, particularly ultrasonic atomizers, heating coils, ovens, etc.

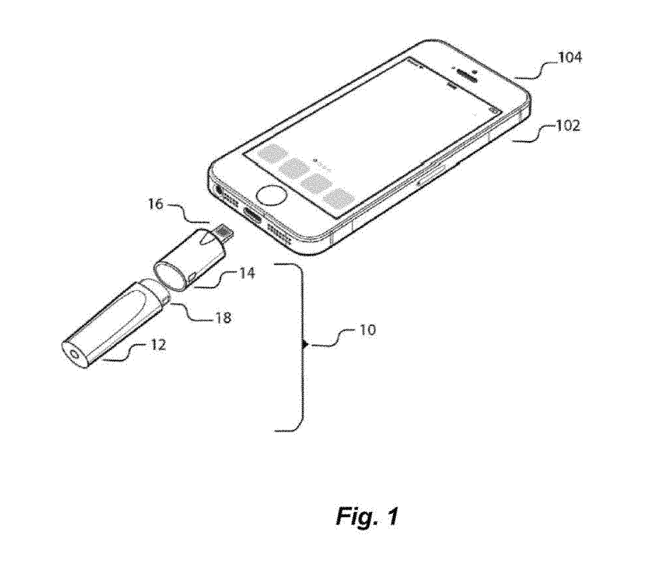

Referring first to FIG. 1, an embodiment is shown schematically of a smart phone e-cigarette assembly, designated generally by numeral 10. Smart phone e-cigarette assembly 10 has no integral source of power, but, instead, derives all electrical power from a power source 102 that is integral with a mobile device 104. As defined above, various consumer devices, such as a smart phone, may serve as mobile device 104 for purposes of practicing the present invention.

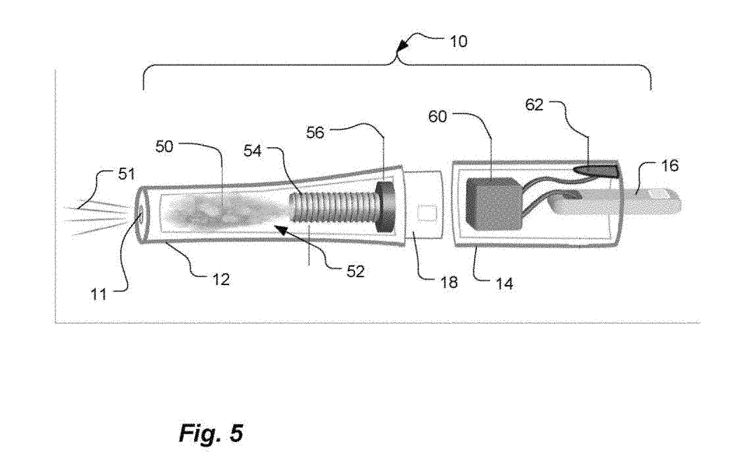

Components of the smart phone e-cigarette assembly 10, in accordance with the embodiment shown in FIG. 1, include an e-cigarette cartridge 12, coupled, by means of coupler 18 to a control module 14. Control module 14 is coupled, in turn, to mobile device 104 via a cell phone prong 16. E-cigarette cartridge 12, which may be disposable, provides for vaporization and inhalation of a vaporized substance that is dispensed from the e-cigarette cartridge 12. The substance to be vaporized may be supplied in cartridge 12, as further discussed below with reference to FIG. 5. Electrical power is conveyed to e-cigarette cartridge 12 from mobile device 104 to control module 14 via cell phone prong 16 and from control module 14 to e-cigarette 12 via coupler 18.

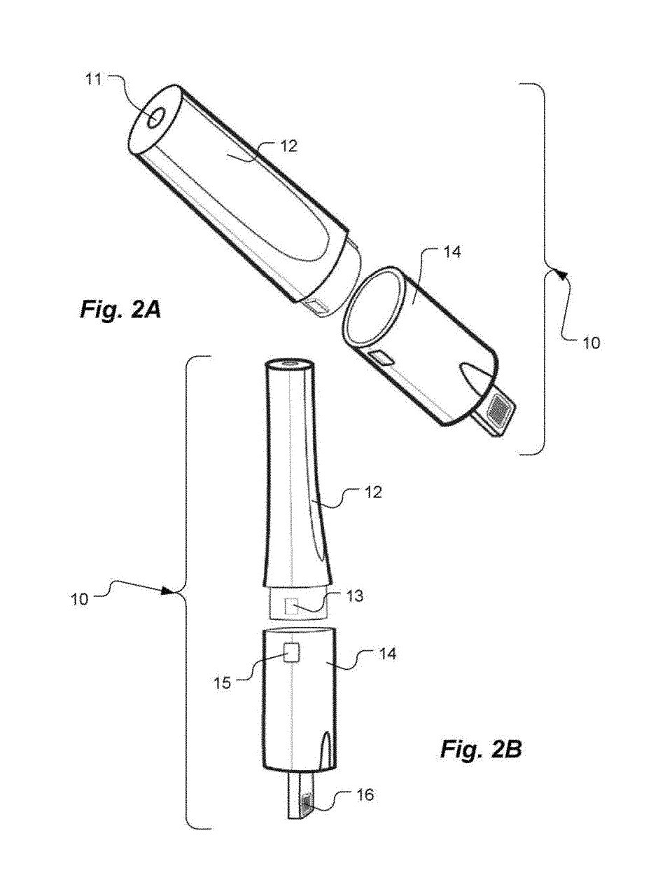

FIGS. 2A and 2B show exploded views, in perspective and from one side, of smart phone e-cigarette assembly 10, including cartridge 12 and control module 14, in accordance with one embodiment of the present invention. Tang 13 may be provided to engage detent 15, thereby securing the coupling of cartridge 12 to control module 14, however it is to be understood that all mechanisms for coupling cartridge 12 to control module 14 are within the scope of the present invention.

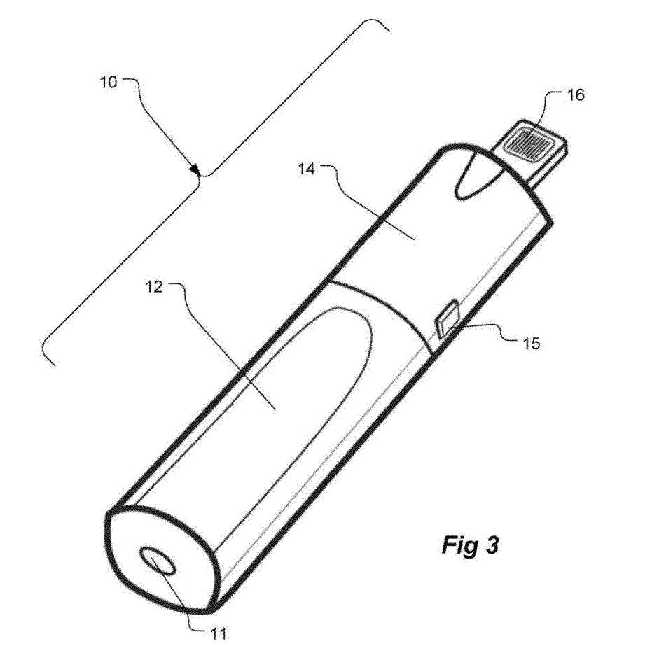

FIG. 3 is a perspective view of smart-phone e-cigarette assembly 10, including component parts cartridge 12 and control module 14. A lumen 11 (otherwise referred to as an “outlet”) allows a user (not shown) to draw substance that has been vaporized inside e-cigarette cartridge 12 as described below with reference to FIG. 5.

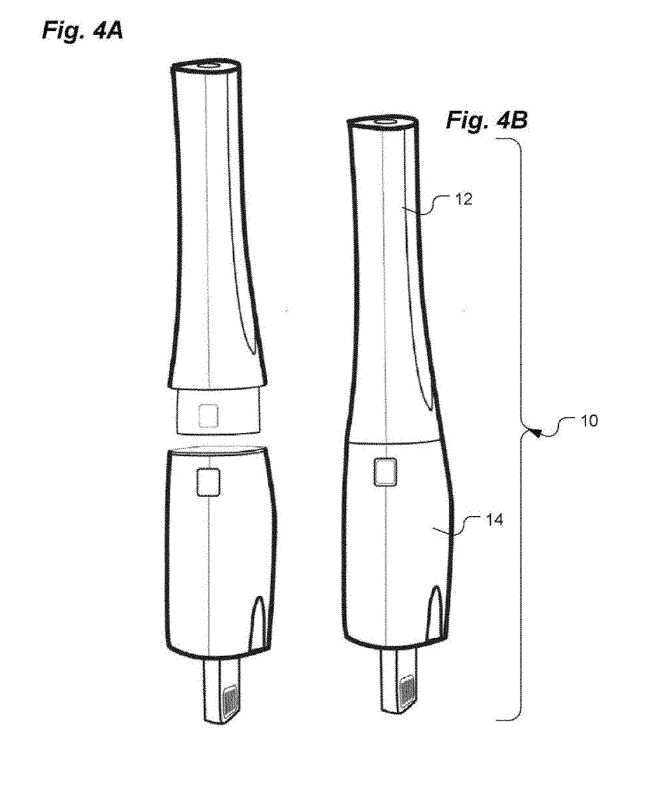

FIGS. 4A and 4B are side views of smart-phone e-cigarette assembly 10, including component parts cartridge 12 and control module 14 in decoupled and coupled states, respectively. Referring now to FIG. 5, a schematic cutaway view is shown of smart-phone e-cigarette assembly 10, including component parts cartridge 12 and control module 14. A substance 50 is supplied within a receptacle volume 52 of cartridge 12. The substance may include nicotine oil dissolved in propylene glycol, for example. The present invention is not limited by the range of substances that may be vaporized within the scope of the invention. Substance 50 may be supplied in either solid or liquid form, where “liquid” includes the case where the substance is suspended within a liquid or solid matrix of a different material composition than that of substance 50. Substance 50 is vaporized when vaporizer 54 is energized. Vaporizer 54 may be a heating element such as a heat coil, for example, or an ultrasonic atomizer, and is not limited within the scope of the present invention. Vaporizer 54 is energized by application of electrical power derived from mobile device 104 via phone prong 16 and coupler 18, as switched by controller 60. Notably, neither cartridge 12 nor control module 14 contains any integral power source, nor is an external power source provided, other than mobile device 104 itself. In the prior art, it has always been understood that a source of power external to the mobile device would be necessary to provide the functionality of vaporizing a substance 50.

Controller 60 is adapted to switch current, and, additionally, includes a microprocessor for receiving commands from mobile device 104 via phone prong 16. Controller 60 may implement a subset or all of the control or reporting functionalities described by Tremplay '945, singly or in combination, as programmed from mobile device 104. Communication of control functions between mobile device 104 and controller 60 preferably uses standard mobile device hardware interface protocols, such as the Apple External Accessory framework, for example, described at developer.apple.com/library/ios/documentation/ExternalAccessory/Reference/ExternalAccessoryFrameworkReference/, which in incorporated herein by reference. Functionalities may include controlling performance characteristics of the e-cigarette cartridge by instructions derived from the mobile device.

Additional features that may be provided, in accordance with alternate embodiments of the present invention, include sensor 56 that detects a pressure differential when a user draws vaporized substance 51 via lumen 11. A sensor that may be used for this functionality is an electronic cigarette pressure sensor supplied by Weifang Qinyi Electron Science & Technology Co., Ltd. of Weifang City, Shandong, China. Additionally, an LED lamp 62 may be provided, in either cartridge 12 or control module 14, that may be illuminated by controller 60 under specified circumstances, such as when vaporized substance 51 is drawn through lumen 11.

The embodiments of the invention described above are intended to be merely exemplary; numerous variations and modifications will be apparent to those skilled in the art. All such variations and modifications are intended to be within the scope of the present invention as defined in any appended claims.

I claim:

1. A method for vaporizing a substance for inhalation by a user, the method comprising:
a. coupling an e-cigarette cartridge that includes a vaporizer to a control module;
b. coupling the control module to a mobile device;
c. coupling electrical power from the mobile device to the control module;
d. coupling electrical power from the control module to the e-cigarette cartridge; and
e. vaporizing the substance within the e-cigarette cartridge.

2. A method in accordance with claim 1, wherein coupling the e-cigarette cartridge to the control module includes coupling the e-cigarette cartridge by insertion directly into the control module.

3. A method in accordance with claim 1, further comprising sensing that the substance is being inhaled by a user.

4. A method in accordance with claim 1, wherein coupling the control module to the mobile device includes coupling the control module by insertion of an electrical connector directly to the mobile device.

5. A method in accordance with claim 1, further comprising controlling performance characteristics of the e-cigarette cartridge by instructions derived from the mobile device.

6. A system for vaporizing a substance, the system comprising:
a. an e-cigarette cartridge having no integral power source; and
b. a control module, having no integral power source, for receiving the e-cigarette cartridge, the control module having an electrical connector specifically adapted for connection to a mobile device and for deriving power therefrom.

7. The system in accordance with claim 6, wherein the e-cigarette cartridge includes a receptacle volume for retaining the substance for vaporization.

8. An e-cigarette cartridge for use in a system, the e-cigarette cartridge comprising:
a. a receptacle volume for containing a substance to be vaporized;
b. a sensor for detecting inhalation through the e-cigarette cartridge by a user and generating a sensor signal;
c. a connector for coupling the sensor signal to a control module; and
d. a vaporizer for vaporizing the substance upon receipt of a control signal from the control module.

9. The e-cigarette cartridge in accordance with claim 8, wherein the vaporizer includes a heating element.
